(19) United States
(12) Patent Application Publication
(10) Pub. No.: US 2014/0069558 A1
(43) Pub. Date: Mar. 13, 2014

(54) HotTreads

(71) Applicant: Joseph Donald Favia, Brick, NJ (US)

(72) Inventor: Joseph Donald Favia, Brick, NJ (US)

(21) Appl. No.: 13/573,377

(22) Filed: Sep. 13, 2012

(51) Int. Cl. B60C 99/00

(52) U.S. Cl. 152/152.1

(57) ABSTRACT

A tire defrosting system includes a tire having steel belts and a tire tread covering the steel belts, and a power source electrically connected to said steel belts of said tire. The power source provides electrical current to the steel belts so as to heat and increase the temperature thereof and in turn the tire tread so as to melt an accumulation of snow or ice on the tire thread. The power source, such as a car batter, is electrically connected to the steel belts by a pair of wire conductors. The tire includes a thermometer to monitor the internal temperature thereof and to provide an automatic shutdown mechanism.

### FIELD OF THE INVENTION

The present invention relates to a tire defrosting system.

### BACKGROUND OF THE INVENTION

After a snow storm, cars parked on have ice/snow packed into their tires and into their treads. Cars attempting to stop can struggle due to a lack of traction.

### SUMMARY OF THE INVENTION

The present invention is adapted to keep tires warm by heating the steel belts inside the tire itself. The purpose of the invention is to melt existing snow and ice from automotive tires and their treads in poor weather conditions as well as keeping the tire warm enough to prevent new snow accumulation while the automobile is being used. The present invention can contribute to accident prevention and driver safety during winter months. Two copper wires will run from the positive and negative ends of the car battery and connect to the steel belts of the automobile tires. The battery source will provide energy which will react with the steel belts and produce heat. The heat will in turn heat the tire, particularly the treads. The tires will be heated to a safe, controlled, and comfortable temperature, and hot enough to stop snow from accumulating and defrost existing snow.

### BRIEF DESCRIPTION OF THE DRAWINGS

FIG. 1 is a perspective view of a tire defrosting system in accordance with an embodiment of the present invention.

### DETAILED DESCRIPTIONS OF DRAWING

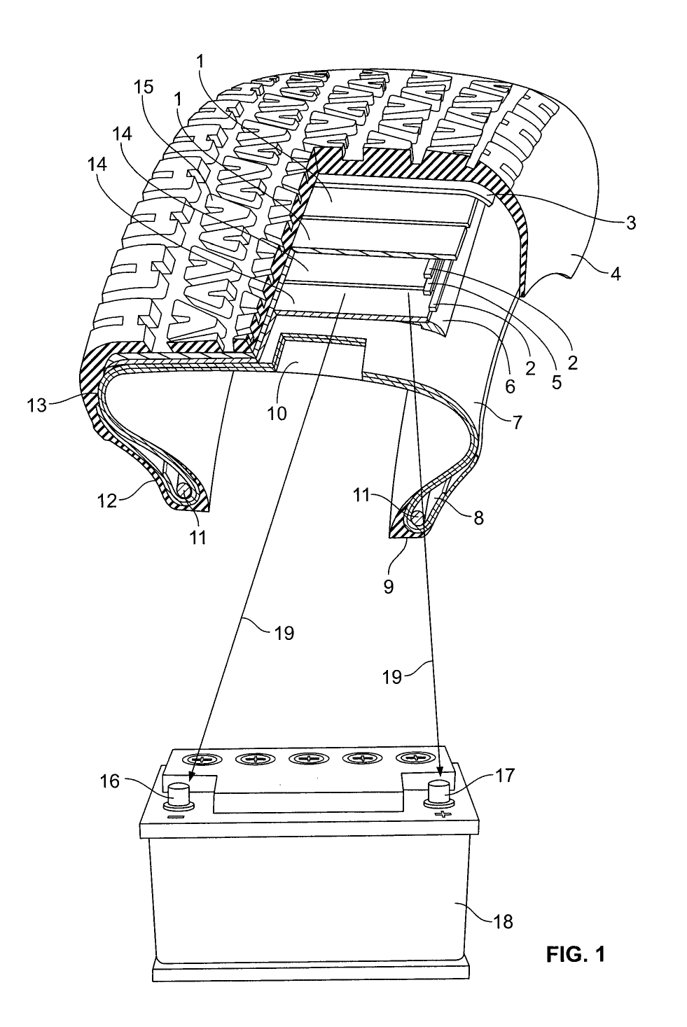

Referring to FIG. 1, a tire defrosting system to quickly and efficiently melt snow and ice from the exterior of automotive tires allowing the tires to operate at their optimal proficiency. In an embodiment, FIG. 1 shows a tire that includes nylon overlays 1, gum strips 2, an undertread 3, sidewalls 4, a belt wedge 5, a cushion 6, body plies 7 terminating at apex 8, a toe guard 9, halobutyl liner 10, beads 11, chafer 12, ply tum up 13, steel belts 14 located between the plies 7 and a tread 15. A power source, such as a car battery 18 having a negative charged receptor 16 and a positive charged receptor 17 is electrically connected to the tire by two copper wire conductors 19. More particularly, the tire will be heated through electrical currents provided by the car battery 18. The electrical currents will be carried through the engine of the car by the two copper wire conductors 19. The copper wire conductors 19 will connect to the steel belts 14 of the car tire. Once connected, the energy (i.e., electrical current) from the car battery 18 will react with the steel belts 14, causing the belts 14 to heat. This heat will, in turn, heat the tires exterior rubber including the treads 15. The rise in temperature of tires rubber surface, including the treads 15, will melt existing snow/ice as well as prevent the accumulation of new snow/ice.

In accordance with the present invention, the car battery 18 will be limited to a certain amount of wattage output to prevent the steel belts 14 from overheating. In an embodiment, the system will include a thermometer within the tire to monitor the internal temperature of the tire and functions as an automatic shutdown mechanism when the tire reaches its optimal temperature.

### LIST OF REFERENCE NUMBERS

1. Nylon Overlays
2. Gum Strips
3. Undertread
4. Sidewall
5. Belt Wedge
6. Cushion
7. Body Piles
8. Apex
9. Toe Guard
10. Halobutyl Liner
11. Beads
12. Chafer
13. Ply Tum Up
14. Steel Belts
15. Tread
16. Negative Charged Receptor
17. Positive Charged Receptor
18. Car Battery
19. Copper Wire Conductor

What is claimed is:

1. A tire defrosting system, comprising:
a tire having steel belts and a tire tread covering said steel belts; and
a power source electrically connected to said steel belts of said tire, said power source providing electrical current to said steel belts so as to increase the temperature thereof and said tire tread so as to melt an accumulation of snow or ice on said tire thread.

2. The tire defrosting system of claim 1, wherein said power source is electrically connected to said steel belts by a pair of wire conductors.

3. The tire defrosting system of claim 2, wherein said power source is a car battery.

4. The tire defrosting system of claim 3, wherein the tire includes a thermometer to monitor the internal temperature thereof.

5. The tire defrosting system of claim 4, wherein said thermometer includes an automatic shutdown mechanism.
